(19) United States
(12) Patent Application Publication
(10) Pub. No.: US 2016/0134946 A1
(43) Pub. Date: May 12, 2016

(54) PRODUCT ADVERTISING IN A MULTI-MEDIA PROGRAM ENVIRONMENT

(71) Applicants: George Glover, Brooksville, FL (US); Bruce D. Miller, North Reading, MA (US); Shannon Sabo, Hudson, FL (US)

(72) Inventors: George Glover, Brooksville, FL (US); Bruce D. Miller, North Reading, MA (US); Shannon Sabo, Hudson, FL (US)

(21) Appl. No.: 14/538,519

(22) Filed: Nov. 11, 2014

(51) Int. Cl. H04N 21/81; H04N 21/454; H04N 21/435

(52) U.S. Cl. CPC H04N 21/812; H04N 21/435; H04N 21/454

(57) ABSTRACT

A video program is displayed for viewing by an individual on a video player device. The individual viewing the program can enter clues discovered in the video program content into a program application running on either a communication device local to the individual or running in device that is remote from the individual. The program application operates to determine whether or not the individual has enter a correct number of valid clues, and if so the individual is permitted to participate in an activity run by the program application.

### 1. FIELD OF THE INVENTION

The present disclosure relates to the inclusion of product images in a video stream for the purpose of advertising the product and the discovery of the images by a viewer in order to participate in an activity subsequent to the video stream being played.

### 2. BACKGROUND

Product advertising is currently ubiquitous in multi-media programming transmitted over the public airwaves or private network (wired or wireless) for consumption by public or private audiences, and advertising revenue generally serves to offset the cost of multi-media program production and to compensate the distributors of the multi-media programs for broadcasting or transmission expenses. Typically, product manufacturers purchase advertising time from the distributors, or other entity, and product advertisements are played during commercial breaks or during times that a video program is not available to be viewed by an audience. This advertising time can be more or less costly to purchase depending upon the content of the program (i.e., the show being played) and the time during the day, week or year that the program is available to be viewed. In this regard, the distributors of multi-media program content make every effort to maximize their advertising revenue by tailoring the program content and the time at which it is transmitted to be viewed by the largest audience possible.

### 3. BRIEF DESCRIPTION OF THE DRAWINGS

The present invention can be best understood by reading the specification with reference to the following figures, in which:

FIG. 1 shows a video player 10 and a computational device 40 that runs a program application used by a viewer to interact with program content being displayed on the player screen.

FIG. 2 shows the computational device of FIG. 1 with an application screen populated with clue information.

FIG. 3 shows the computational device of FIG. 2 displaying a screen that includes viewer activities that can be selected.

FIG. 4 shows the computational device of FIG. 3 running an activity selected by the viewer.

FIG. 5A is a block diagram showing the functional elements comprising the program application in FIG. 1.

FIG. 5B is a block diagram showing functional elements comprising a viewer activity A.

FIG. 5C is a block diagram showing functional elements comprising the computer application 35.

FIG. 6A is a logical flow diagram describing logic used to control the operation of the program application to identify valid clues and to determine whether a viewer is permitted to participate in an activity.

FIG. 6B is a continuation of FIG. 6A.

FIG. 7 is a logical flow diagram describing logic used to control the application during the time a viewer is interacting with viewer activity content.

### 4. DETAILED DESCRIPTION

Methods used to promote or to bring products to the attention of an audience typically vary depending upon the medium over which the advertising content is transmitted or broadcast. Typically, product advertising that is transmitted over either a public network (typically air medium) or over a private e network (typically cable, optical or satellite) and played by a television occurs during a commercial break, or during a time that a video program is not available to be viewed by an audience. This advertising format provides viewers with an opportunity to tune out the advertising content during the course of a program, or if the viewer is recording the video content with a digital video recording (DVR) device, they can easily skip the advertising content when playing the recorded program. All of this behavior can frustrate a product advertisers attempts to reach a maximum number of viewers in an audience.

Product promotion or advertising that is transmitted over the Internet during an internet video program can be presented to the viewing audience as a pop-up that appears in the field of the video content or product promotions can embedded in the content in some other manner. Such video programming can be viewed on a computer device that is configured to receive and display content in the format in which it is transmitted, and typically, these computer devices can be configured to disable pop-ups or configured with an advertising filter, which has the effect of frustrating product advertiser's attempts to reach the widest possible audience. Regardless of the methodology used to present product advertising to a viewing audience, and regardless of the device on which the video production is being viewed, much of the viewing audience can easily and effectively tune out the product advertising content, which on the one hand results in the product advertisers not be able to make the most efficient use of the product advertising funds and on the other hand it can result in reduced advertising revenue to the network organizations that are responsible for broadcasting or transmitting the video programming.

In order to overcome the problems associated with an audience ignoring product advertising, and in order to provide those organizations responsible for transmitting multi-media programming content (content distributor) over a network with increased advertising revenue, we have invented a methodology that promotes advertising content by incenting program viewers in a multi-media program viewing audience to pay attention to product advertising by permitting individual multi-media program viewers to participate in an activity (viewer activity) if they detect and enter a particular number of valid product images or clues that are included in a multi-media program during the time that the program is played. The activity can be an opportunity to win money or to win a prize, to play a game or to enter into some other activity made available for selection by the viewer. The viewer may be required to watch advertising content associated with product images prior to being permitted to participate in the activity or the viewer may be required to watch advertising content during the course of participating in the activity, or in order to continue participating in the activity. These and other aspects of the invention are described below with reference to the Figures.

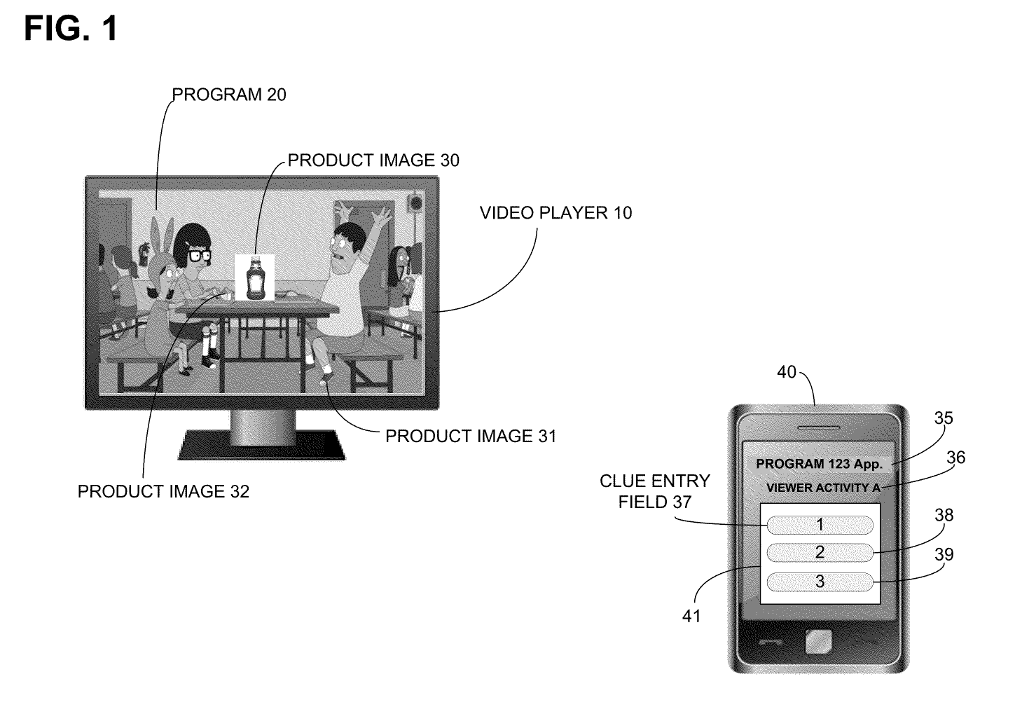

FIG. 1 shows a multi-media player device 10, or simply player device, playing multi-media program content which is labeled as program 20. The player device 10 can be a television, a computer with display or any stationary or portable electronic device capable of receiving video content information over a public or private network and playing it on a display. Program 20 can be any live or pre-recorded multi-media content transmitted by a content distributor such as a television network or an Internet content distributor, and transmitted over an appropriate network to the player device 10. The program content can be a television show or movie transmitted over the air or over a cable network (Internet o content or cable network content). After the multi-media content information is received by the player device, the content can either be played immediately or stored for later viewing. For the purpose of this description, the program 20 is illustrated as a television show with animated multi-media content showing children eating in a cafeteria. Product images for which product manufacturers pay advertised time or space during the course of the program 20 can be included in the content of the program and displayed to viewers when played on a player device. FIG. 1 shows three product images that are included in the content currently being played, a product image 30 represents a bottle of ketchup manufactured by company A, a product image 31 represents a shoe manufactured by company B, and a product image 32 represents a fast food item prepared by a company C. Each of these product images are included in the content as a clue to be discovered by a viewer of the program 20, and each image can include the brand name of the product manufacturer. The product images can be actual physical products placed in a set during the time a program is being recorded, or the product images can be virtual images superimposed upon the program content by a digital video editing tool. Regardless of the manner in which the product images are placed into the program content, these clues or product images can be included in the content played by the player device 10 for a specified period of time, or for the duration that the program 20. The period of time that the product image is displayed can be controlled by a digital multi-media editing process or by the source of the multi-media content and can depend, among other things, on a contract that the manufacturer has with the content distributor.

After a viewer (not shown) of the program 20 recognizes that a product image is a clue, they can enter the identity of the clue into a computer application or multi-media program application 35 (the application) that is running on either a local communication device 40, or running on a remote computational device connected to a wide area network such as the Internet and accessible by a client application running on the communication device 40. The multi-media program 20 content can include instructions that the viewer can use to access the remote application, or instructions that the viewer can use to download the computer application to their local communication device 40. The local communication device, in this case, can be a smart phone, a tablet, laptop, desktop computer or wearable computational device that can be connected to either a wireless or wired network.

The computer application or program application 35 (of simply application 35) can be designed or configured, by the content distributor (TV network or Internet content distributor), to receive the identities of the various clues discovered by the program viewer as input to the application 35. The application 35 can receive input from the viewer in several different ways. The input can be text, the input can be speech, or the input can be the result of a product image being selected by a screen cursor operating in conjunction with the player device 10.

The content comprising the program 20 has three product images or clues that can be discovered by the viewing audience, although more or fewer clues can be included in any particular program. A separate computer application, such as the application 35 running on the communication device 40 in FIG. 1, is associated with each different multi-media program, and can be specially configured with the number and the identity of the product images or clues included in that program. A viewer can be provided with one or more instructions, included in the program content, which they can use to assist them with identifying product clues included in the content. For example, the viewer can be instructed that all of the clues included in a program represent food products, vehicle products, or clothing products and that all of the product images or clues include the brand name of the product. The clue instructions can change during the time that the program is played or viewed. Regardless, the purpose of discovering the clues is to enter valid product clues into the application 35 in order to be permitted to participate in an activity.

Continuing to refer to FIG. 1, the communication device 40 is illustrated to be running the application 35 associated with the program 20 content. An instance of an application screen 41 has three separate fields, labeled 1, 2, and 3, that are provided for the viewer to enter the identity of clues into the program application. While the application 35 has only three of these fields, it should be understood that there can be more or fewer fields displayed in the screen 41 depending upon the number of clues that can be discovered in the program 20. Each field can be a general field and accept any clue, or each field can be dedicated to a particular product clue, or the fields can be mixed. According to an embodiment in which each clue field is dedicated to a particular product clue (in this case each product image is introduced into the video content stream serially, wherein the product image 30 is introduced first, the product image 31 is introduced second and the product image 32 is introduced third), the first product image or clue has to be entered into the first field 37, the second product clue has to be entered into field 38 and so forth. Configuring the application 35 in this manner can make it more or less difficult to receive permission to participate in any particular activity.

As described earlier, a program viewer activity can require that some minimum number of valid product clues be entered by the viewer into the application 35 in order to be permitted to participate in the activity. This minimum number of valid product clues can be configured in the application by the organization responsible for broadcasting the video content (content distributor) or by some other third party organization responsible for the operation of the program application.

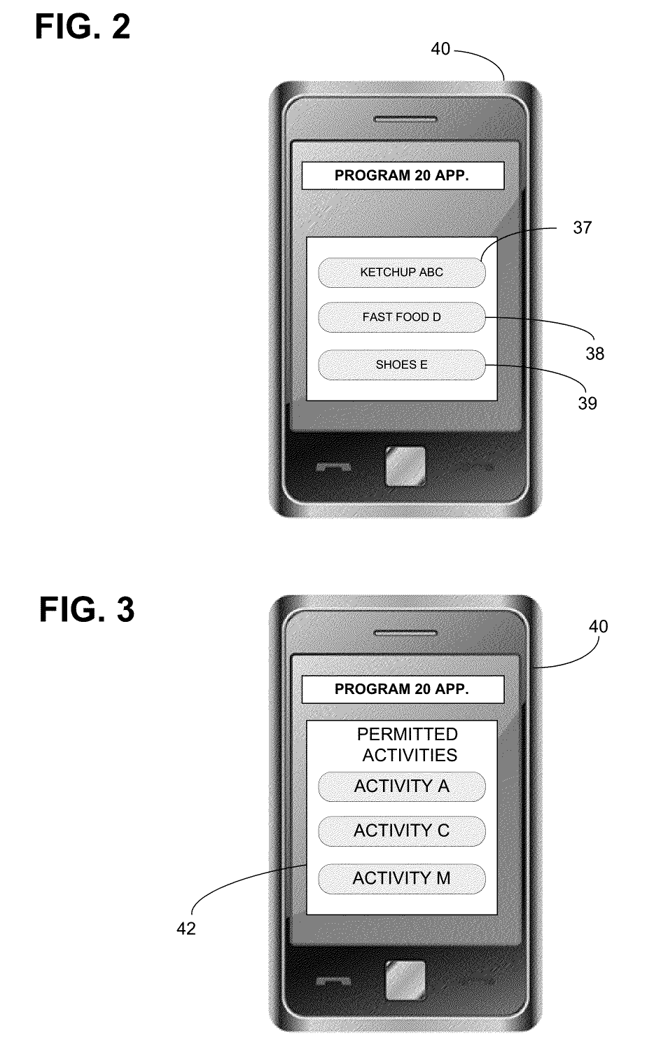

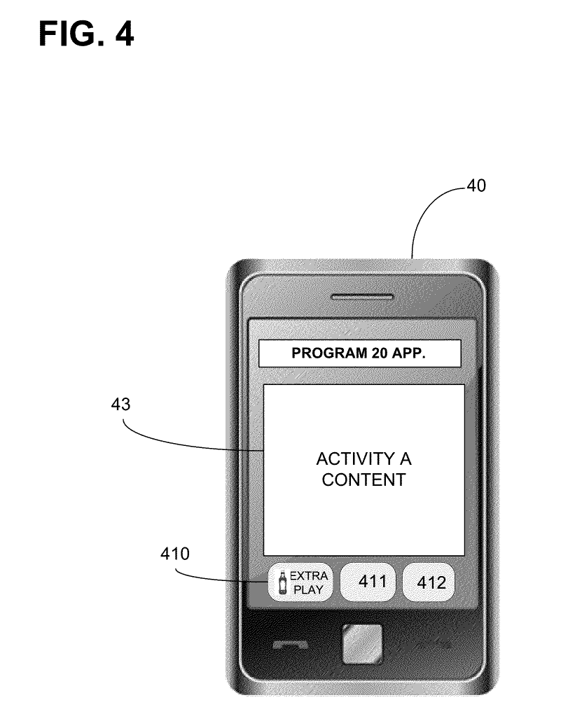

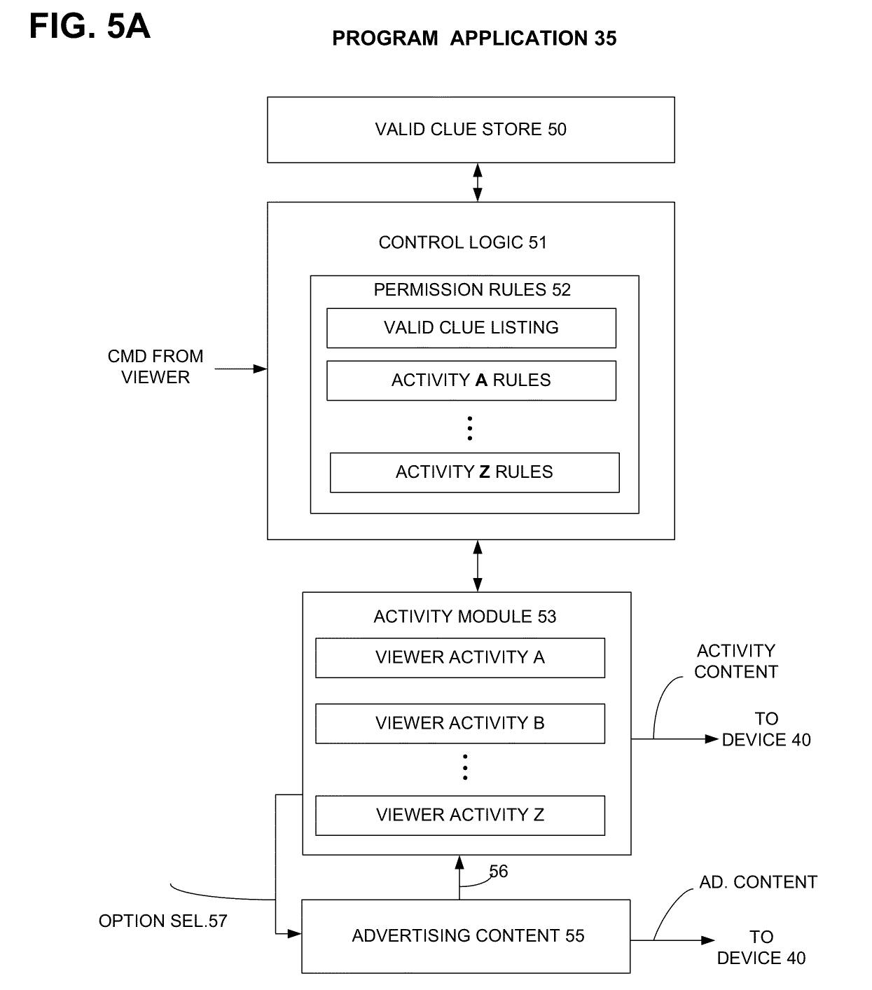

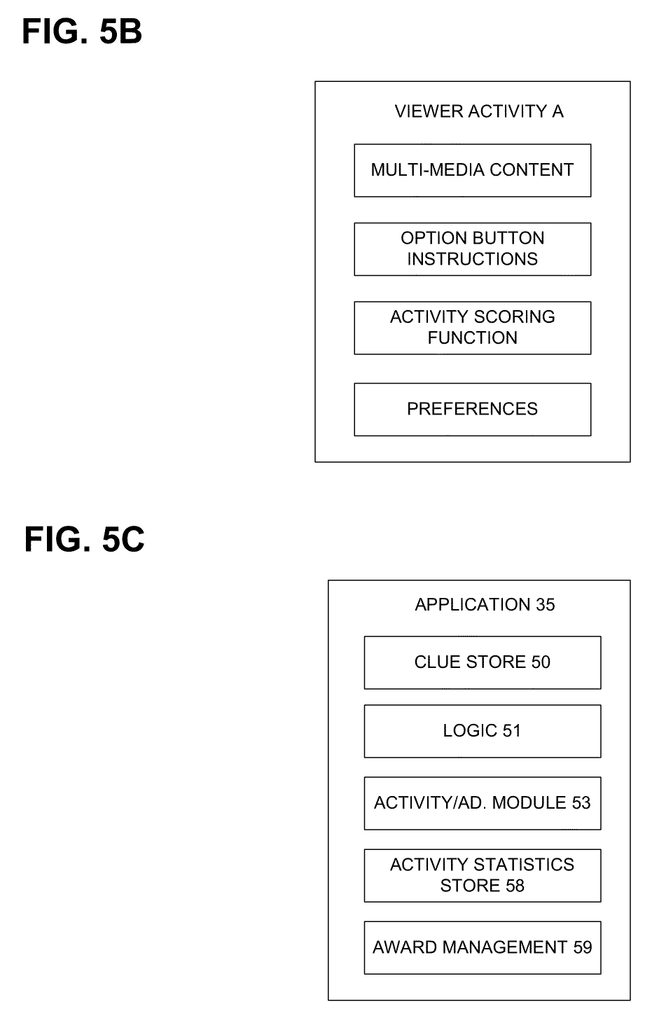

Turning now to FIG. 2, the communication device 40, described earlier with reference to FIG. 1, shows the application 35 displaying the screen 41 with each of the three clue entry fields populated with clue information, which in this case is the identity of the product images discovered by a viewer of the program. As will be described later with reference to FIG. 5A, the application 35 operates to determine how many activities a viewer is permitted to participate in depending upon the number of clues they discover in a program. The number of the activities that a viewer is permitted to participate in is determined by logical computer instruction running in conjunction with the application 35. According to the embodiment described with reference to FIG. 1, a viewer can discover up to three clues in the program 20, and in the event that the viewer discovers and enters all of the clues into the application 35, they are permitted to participate in activity A, C and M as shown on the application screen 42 in FIG. 3. The viewer can select any one of the activities displayed in the screen 42, and after selecting an activity the application displays another screen 43 (described with reference to FIG. 4) in which is displayed some content that the viewer can interact with.

The content displayed in the application screen 43 shown in FIG. 4 can be content comprising video, audio, and textual information (multi-media information), or only video or audio information, or the content displayed in the application screen 43 can be content comprising textual information. Regardless of the type of content, the application can operate to allow the viewer to interact with the content in order to play a game (if the content relates to a game) or to interact with the content in any manner that affects the progress of the activity 35 in some manner (the game continues for instance). Also shown in the application 35 are advertiser or option buttons 410, 411, and 412. Each of these buttons can be selected by a viewer permitted to participate in the activity to control some aspect of the activity and to display advertising content to the viewer. If the viewer selects the option button labeled 410, an advertisement control signal is sent to advertising control logic (described later with reference to FIG. 5) that operates to display advertising content relating to the ketchup brand ABC. This content can be audio, video or both audio and video content, and the viewer may or may not be able to interact with this content. According to this embodiment, selection of the button 410 can also allow the viewer to continue participating in the activity at the end of a session (end of the session in this context means that the game is over) and after some advertising content is played by the program 20 application. The functional elements comprising the program application 35 are described below with reference to FIG. 5.

FIG. 5A is a block diagram showing functional elements comprising an embodiment of the application 35 running on a communication device such as the device 40 described earlier with reference to FIG. 1. The application 35 has a valid clue store 50, control logic module 51 comprised of permission rules 52, and an activity and advertising content module 53. The store 50 maintains a listing of clues entered by a program 20 viewer into the application 35 that the logic 51 determines are valid. The store 50 can maintain valid clue information that can be a product type description corresponding to a product image discovered in program content, such as a hamburger, a shoe, a drink, or a condiment, of the clue information can be a product brand displayed on the product image, or the clue information entered by the viewer can be any description characteristic corresponding to the product image being displayed in the program. The clue information entered by the viewer and determined to be valid by the logic 51 can be maintained by the application 35 for as long as it takes the logic 51 to determine that the clue is a valid clue or for as long as it takes the logic to determine if the viewer is permitted to participate in any activities, and how many and which activity the viewer is permitted to participate in, but this information can be maintained longer.

The control logic 51 referenced in FIG. 5A operates on the clue information maintained in the store 50 and on information comprising the permission rules 52 to, as described earlier, determine whether a viewer has discovered and correctly entered information corresponding to a valid clue, and that the number of valid clues entered by the viewer is equivalent to at least a threshold number (configured in the permission rules 52). As described earlier, this threshold number of clues can be configured by a program content distributor to be any value depending upon the number of different product images that are displayed during the time the program content is played. More specifically, the permission rules 52 comprise a listing of clues (having one or more entries) that are valid for a multi-media program, such as the program 20 described with reference to FIG. 1, and one or more activity rules A to Z. Each one of the activity rules can be configured by the content distributor to include a threshold value that the logic 51 compares to the number of valid clue discovered by the viewer and entered into the application 35. Provided the number of valid clues entered by the viewer is at least equivalent to the threshold value, they are permitted to participate in at least one, or possibly more than one activity, and a list of the activities from which the viewer can select to participate in is displayed on the communication device 40 screen. In the event that a viewer discovers and correctly enters information corresponding to more than the threshold number of clues, the logic 51 can operate, in conjunction with the rules 52, to permit the viewer to participate in more activities than they would otherwise be permitted to participate in if they only discover a number of clues equal to the threshold value. The type of information that is required to be entered into the application 35 by the viewer can change from program to program, or from content distributor to content distributor, and the viewer can be instructed by the application or by content included in a program what information is required to be entered. The permission rules 52 are described in greater detail below.

Continuing to refer to FIG. 5A, each instance of an activity rule (A-Z) comprising the permission rules 52 corresponds to a particular activity that a viewer can be permitted to participate in, and each instance of an activity rule can have a threshold value this is different or the same as any other instance of an activity rule. For example, activity A rules can have instructions that only permit a viewer to participate in this activity if they discover a number of clues that is greater than a threshold number, or it can have instructions that permit a viewer to participate in this activity if they discover a number of clues that is equivalent to the threshold number. Each of the other activity rules can have similar or different instructions.

With further reference to FIG. 5A, the logic 51 can control the application 35 to display one or more instances of an activity from which a viewer can select to participate in. Depending upon whether a viewer is given permission to participate in one or more activities, the logic 51 can control the application 35 to display one or more activities on the screen 42 described with reference to FIG. 3, and any of these displayed activities can be selected by the viewer. The logic 51 can receive commands from the viewer as the result of the viewer selecting any of the virtual buttons displayed on the screen 42 in the three fields labeled Activity A, Activity B and Activity M. After receiving this command, the logic 51 can initialize the activity selected by the viewer and the communication device 40 starts playing the activity which the viewer can then participate in. Content associated with each activity is stored in an activity module 53. The activity module 53 has one or more instances of content, each instance of which is associated with a different viewer activity. In this case, the module 53 has a viewer activity A to viewer activity Z stored. Each viewer activity can have multi-media content that the viewer can interact with while viewing the content. Option button information (described earlier with reference to FIG. 4) can be associated with each instance of the viewer content and be displayed on the same screen as the content for selection by the viewer. A viewer can select any of the option buttons 410, 411 or 412 at any time while they are participating in an activity. Selection of an option button causes the activity that the viewer is participating in to send one or more option instructions to the control logic 51 that are operated on by the logic to control which one of multiple instances of advertising content 55 are played on the user device 40 to be displayed. Further, one of the option instructions sent to the control logic 51 can be used by the logic to control the operation of the application 35 to permit the viewer to continue participating in the current activity (another play), to participate in a different activity, or to participate in an additional activity that they were not previously permitted to participate in, or to control the application 35 in some other manner. The process by which a program viewer can log into and be authenticated by the application 35 is not described here in any detail, as any number of well know and understood methodologies can be employed to accomplish this.

As described above with reference to FIG. 5A, each viewer activity A-Z comprises activity content and option button instructions, and each one of the viewer activities can also have an activity scoring function. The elements comprising a viewer activity are described in more detail as follows in FIG. 5B. As shown in FIG. 5B, the viewer activity A comprises multi-media content which can be a video game, it can be a game that does not have any video content, or it can be any type of content that a viewer can interact with in order for the activity to be completed. Associated with the viewer activity are one or more option buttons, and each option button has at least a first instruction that, after a button is selected, can be operated on by the logic 51 to control the application 35 to play one or more instances of advertising content 55, and can have at least a second instruction that can be operated on by the logic to control the application to permit the viewer to participate one or more optional activities. Also shown is an activity scoring function that maintains a current quantitative accounting of the viewer's success in participating in the activity. The accounting of the viewer's success can be maintained as an integer value or in some other form, regardless, the quantitative measure of the viewer's success can be used by an award management module (illustrated in FIG. 5C) to determine whether the viewer earns a prize as the result of their interaction with an activity, whether the activity is completed or not, and one or more measures of multiple viewers success can be maintained in an activity statistics store also illustrated in FIG. 5C. Also shown, is a preferences function that maintains a current listing of the types of activities a program viewer participates in most. In the event that the application 35 permits the program viewer to participate in a large set of activities, the number of activities that are displayed to the viewer for selection can be controlled to a reasonable number so that the viewer can more easily select an activity of interest to them.

FIG. 5C is a high level diagram showing the functional elements comprising the application 35. As described earlier with reference to FIG. 5A, the application 35 has a store of valid clues 50, it has logic 51, and a viewer activity and advertising content module 53. As shown in FIG. 5C, the application 35 can also have an activity statistics store 58 and an award management function 59. Quantitative information maintained in the activity statistics store 58, described earlier with reference to FIG. 5B, can be accessed by program content distributors for the purpose of determining which activities are most popular, to determine which viewer activities more or less easy to complete (based upon a score), or for other purposes. Depending upon the quantitative information associated with each activity, a content distributor may be able to charge more or less for advertising time during the course of a program, or charge more for the advertising content played as the result of a viewer selecting an option button. Finally, the award management function 59 can use the information maintained by the activity statistics store 59 to award cash or other types of prizes to a viewer participating in one or more activities. The type and value of the award can be determined by, among other things, advertising revenue associated with any particular viewer activity, it can be determined by the success with which a viewer participates in an activity, or it can be determined in some other manner.

Previously, the viewer is described as entering clues into a communication device 40 that is a separate physical device from the player 10, but this does not have to be the case. In another embodiment, the player 10 can be an interactive device (such as an interactive television device) that can either run the application 35 or a client application. In this case, the viewer can use a remote control device to point to and select clues as they appear on the player 10 screen. Once the clues are selected, they can be automatically entered into the application 35 in a manner similar to that described with reference to FIG. 2. Alternatively, it the player 10 has a touch screen, the viewer can identify and select clues by simply touching the screen, and the clues are automatically entered into the program application as before.

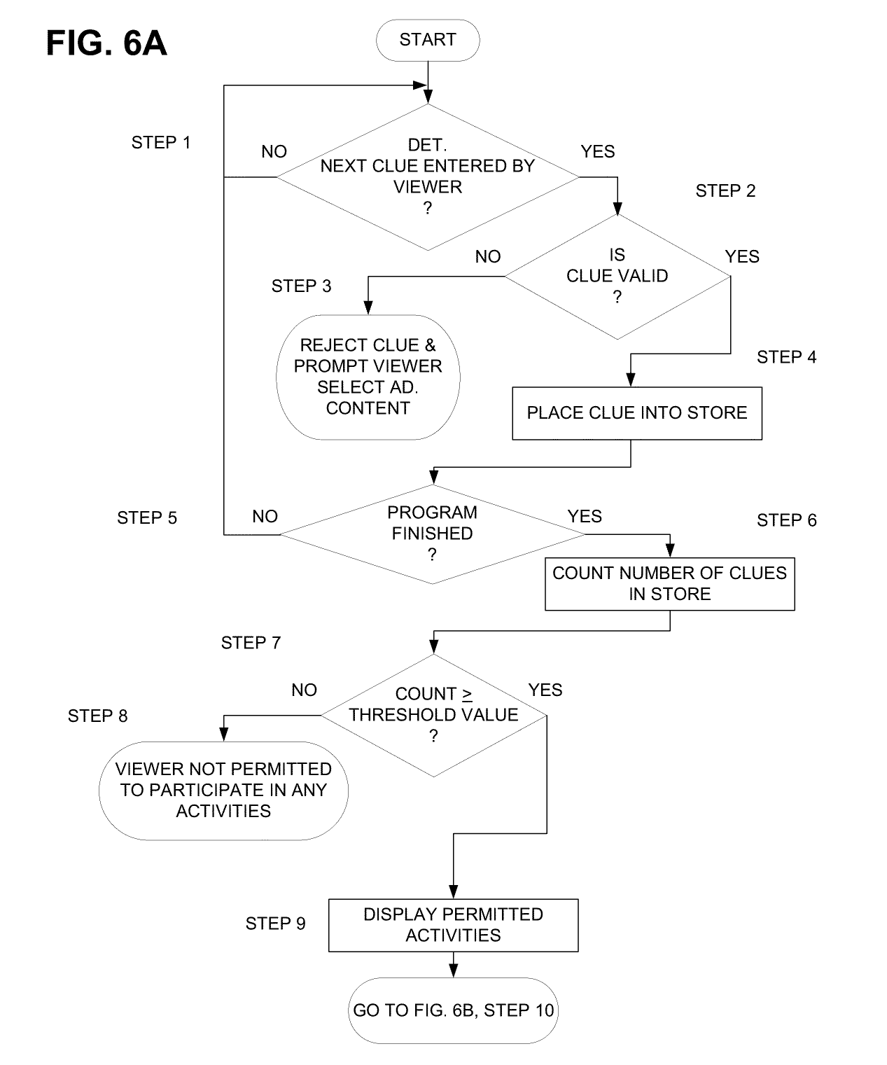

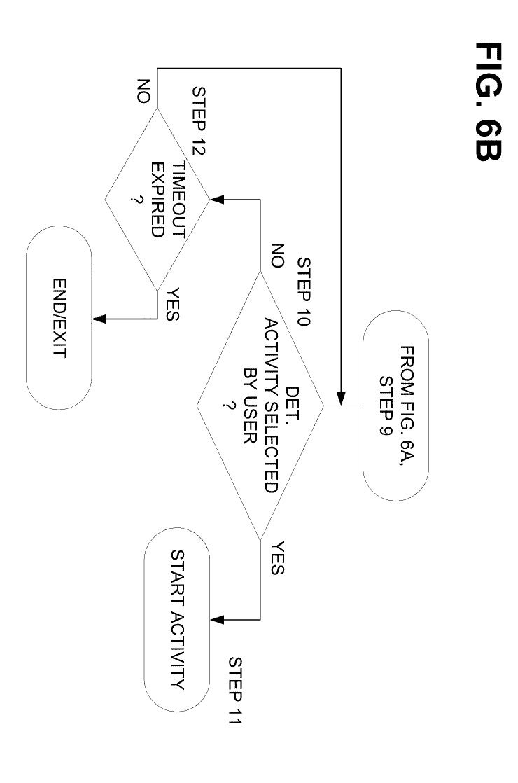

As described earlier with reference to FIG. 5A, the control logic 51 operates to determine whether or not a viewer is permitted to participate in any viewer activities and it operates to control the application to play the activities and to control the operation of the optional button functionality. The operation of this logic is now described with reference to FIGS. 6A and 6B. Referring first to FIG. 6A, if in Step 1 the logic 51 detects the first/next clue entered into the application 35 by the viewer, and in Step 2 the logic 51 determines whether or not the clue is valid. It may be that the viewer enters an invalid clue into the application, and if this is the case, the logic can operate to not place the clue into the store 50. In order to determine whether a clue entered by the viewer is valid, the logic 51 examines each entry in the clue listing comprising the rules 52 in FIG. 5A and compares the most recent clue entered by the viewer to each entry in the clue listing for a match. If the logic detects a match, then the clue is valid, and in Step 4 the clue information is maintained in the store 50, otherwise the logic determines that the clue is not valid and in Step 3 the clue is discarded and the viewer can be notified that the clue is not valid, giving them an opportunity to enter a valid clue.

Continuing to Step 5, if the program 20 is finished, the process proceeds to Step 6 and the logic causes the clues then maintained in the store 50 to be counted, and in Step 7 the clue count is compared to each of the threshold values configured in the activity rules A to Z. If the clue count is not equal to any of the threshold values configured in any of the activity rules, then in Step 8 the viewer is notified that they are not permitted to participate in the activity and the application terminates. On the other hand, if in Step 7 the logic determines that the clue count is equal to or greater than one or more of the threshold values set in the activity rules, then in Step 9 the logic causes each of the one or more activities corresponding to these rules to be displayed, in the screen 42 described with reference to FIG. 3. Referring now to FIG. 6B, In Step 10, the application 35 either detects or does not detect that the program viewer selects an activity displayed in the screen 42, and if an activity is selected the process proceeds to Step 11 and the application 35 starts the selected activity. As previously described, this activity can be a video game, a quiz, or any other activity that the viewer can interact with in some manner. On the other hand, if the application 35 does not detect that an activity is selected, the process proceeds to Step 12 and the application determines whether a timeout threshold is reached. If not, then the process returns to Step 10, otherwise the process proceeds to Step 13 and the program viewer is either prompted to log out of the application or the application 35 simply terminates.

With continued reference to FIG. 6A, and in an alternative embodiment, if in Step 2 it is determined that information entered and detected in Step 1 is not valid, in Step 3 the program viewer can be notified of this, and the program viewer can be prompted to select and watch advertising content. The advertising content selections can be displayed by the program application 35 to the viewer for selection, and once selected the advertising content can be displayed on the device 40 screen 43 shown in FIG. 4. The advertising content can include an image of a product that is a clue to be discovered by the program viewer, or the advertising content can provide some indication to the program viewer what valid product information can be entered into the application 35. If the program viewer enters the valid product information into the application, the process can proceed to Step 4.

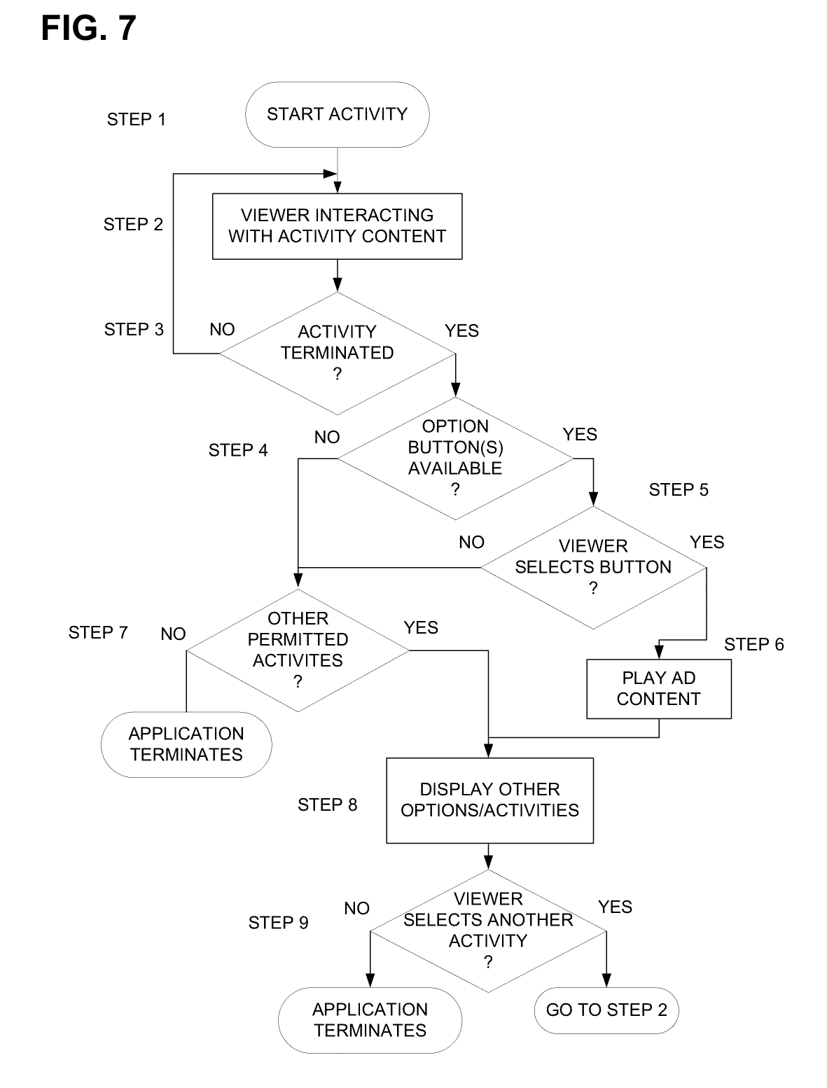

As previously described with reference to FIG. 4, each activity can display option buttons, that are pointers to advertising content and optional activity, that the viewer can select during the time they are participating in the activity or after the activity has ended. In this regard, a viewer can select any of the buttons 410, 411 and 412, described with reference to FIG. 4, to initiate the playing of advertising content and/or to be permitted to continue to participate in the current activity, another iteration of the current activity or to participate in another activity that they are or are not otherwise permitted to participate in. The operation of the application 35 after a viewer has selected any one of the activities (A-Z) to participate in will now be described with reference to FIG. 7. In Step 1, and subsequent to the viewer in FIGS. 6A and 6B selecting an activity that they are permitted to participate in, the selected activity is displayed on the device 40 screen and in Step 2 the viewer starts to interact with the activity content. In Step 3, if the content associated with the activity is still playing, then the process returns to Step 2 and loops between Steps 2 and 3 for as long as the content associated with the activity is playing on their device 40, at the point that the activity terminates, the process proceeds to Step 4 where the viewer can determine whether or not there are any option buttons available to select. If in Step 4 there are no option buttons displayed in screen associated with the activity content, the process proceeds to Step 7, otherwise the process proceeds to Step 5 and the viewer can select a button or not. If the viewer does not select a button, the process proceeds to Step 7. On the other hand, if the viewer selects an option button the process precedes to Step 6 and the application 35 plays the advertising content on the user device and the process proceeds to Step 8. In Step 8, the activity screen (such as the screen 40) can display one or more activities (i.e., another play or other different activity options) for selection, and in Step 9 the viewer can select any one of the activities displayed in Step 8. Returning to Step 7, the logic 51 determines whether the viewer is permitted to participate in any other activities, and if so the process proceeds to Step 8, otherwise the application terminates.

While the logical process described with reference to FIG. 7 assumes that the activity terminates prior to a viewer being able to select an option button, this does not necessarily have to be the case. In another embodiment, the viewer can be permitted to select an option button at any time subsequent to the start of their interaction with an activity.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

We claim:

1. A method of promoting advertising content to multi-media program viewers, comprising:
playing a multi-media program by a multi-media player device, the multi-media program comprising content having one or more product images;
providing the multi-media program viewers with one or more instructions to assist in detecting the one or more product images;
discovering, by a multi-media program viewer, at least one of the one or more product images and entering information associated with the discovered at least one product image into a computer application associated with the multi-media program, and the computer application determining that the information associated with the at least one discovered product image entered by the viewer is valid and storing the information as a valid entry; and
determining, by the computer application, that the number of stored valid entries is equal to or greater than a threshold value, and notifying the multi-media program viewer that they are permitted to participate in at least one viewer activity associated with the computer application.

2. The method of claim 1, wherein the computer application runs on the multi-media player device or on a computational device that is separate from the multi-media player device.

3. The method of claim 1, further comprising the computer application displaying one or more permitted viewer activity options from which the multi-media program viewer can select to participate in, and the video program viewer selecting any one of the one or more permitted viewer activities.

4. The method of claim 3, further comprising the computer application operating to display content associated with the selected viewer activity that the multi-media program viewer is permitted to participate in.

5. The method of claim 4, wherein the content associated with the viewer activity is a multi-media content.

6. The method of claim 5, wherein that content is any one or all of a video content, a still image content, and a textual content.

7. The method of claim 4, wherein the content associated with the selected viewer activity has one or more option buttons for selection by the multi-media program viewer, and the option buttons are selectable before, during, or after the time that the multi-media program viewer interacts with the content associated with the selected viewer activity.

8. The method of claim 7, wherein each one of the one or more selectable option buttons is associated with a first set of computer instructions, and this first set of computer instructions, when operated on by the computer application as the result of a first option button being selected by the multi-media program viewer, causes advertising content to be played.

9. The method of claim 8, wherein the advertising content is any one or a multi-media content, a video content, and an audio content.

10. The method of claim 7, wherein each one of the one or more selectable option buttons is associated with a second set of computer instructions, and this second set of computer instructions when operated on by the computer application, as a result of a second option button being selected by the multi-media program viewer, results in a determination that the multi-media program viewer is permitted to continue to participate in a current viewer activity or to participate in another viewer activity that the viewer is not otherwise permitted to participate in.

11. A method of promoting advertising content to multi-media program viewers, comprising:
playing a multi-media program by a multi-media player device, the multi-media program comprising content having one or more product images;
providing the multi-media program viewers with one or more instructions to assist in detecting the one or more product images;
discovering, by a multi-media program viewer, a product image in the content comprising the multi-media program and entering information associated with the discovered product image into a computer application associated with the multi-media program;
determining, by the computer application, that the information associated with the product image entered into the computer application by the video program viewer is not valid;
displaying one or more advertising content options from which the multi-media program viewer can select, the advertising content promoting a product associated with the one or more product images comprising the video program; and
selecting, by the multi-media program viewer, any one of the one or more advertising content options, and the multi-media program viewer watching the advertising content.

12. The method of claim 11, further comprising discovering, by the multi-media program viewer, another product image in the content comprising the multi-media program, entering information associated with the discovered product image into the computer application and the computer application determining that the information entered is valid and storing the valid information as a valid entry; and
determining, by the computer application, that the number of stored valid entries is equal to or greater than a threshold value, and notifying the multi-media program viewer that they are permitted to participate in at least one viewer activity associated with the computer application.

13. The method of claim 12, further comprising the computer application displaying one or more permitted viewer activity options from which the multi-media program viewer can select to participate in, and the video program viewer selecting any one of the one or more permitted viewer activities.

14. The method of claim 13, further comprising the computer application operating to display content associated with the selected viewer activity that the multi-media program viewer is permitted to participate in.

15. The method of claim 14, wherein the content associated with the selected viewer activity has one or more option buttons for selection by the multi-media program viewer, and the option buttons are selectable either before, during, or after the time that the multi-media program viewer interacts with the content associated with the selected viewer activity.

16. The method of claim 15, wherein each one of the one or more selectable option buttons is associated with a first set of computer instructions, and this first set of computer instructions, when operated on by the computer application as the result of a first option button being selected by the multi-media program viewer, causes advertising content to be played.

17. The method of claim 15, wherein each one of the one or more selectable option buttons is associated with a second set of computer instructions, and this second set of computer instructions when operated on by the computer application, as a result of a second option button being selected by the multi-media program viewer, results in a determination that the multi-media program viewer is permitted to continue to participate in a current viewer activity or to participate in another viewer activity that the viewer is not otherwise permitted to participate in.

18. A system for promoting advertising content to a multi-media program viewers, comprising:
a multi-media player device operating to receive multi-media program content over a network and to display the multi-media program content to a video program viewer, the multi-media program content having one or more product images; and
a computational device running a computer application, associated with the multi-media program content, that operates to:
provide the multi-media program viewer with one or more instructions to assist in detecting the one or more product images;
receive product information that is discovered and entered into the computer application by the multi-media program viewer and which is associated with the one or more product images comprising the multi-media program content;
determining that the product information entered into the computer application by the program viewer is valid and storing the valid information as a valid entry;
determining that the number of stored valid entries is equal to or greater than a threshold value; and
notify the multi-media program viewer that they are permitted to participate in at least one viewer activity associated with the computer application.
